(19) United States
(12) Patent Application Publication
(10) Pub. No.: US 2023/0116980 A1
(43) Pub. Date: Apr. 20, 2023

(54) SEAT ADJUSTING STRUCTURE, ADJUSTING METHOD THEREOF AND ENGINEERING MACHINERY SEAT

(71) Applicants: Xuzhou XCMG Excavator Machinery Co., Ltd., Xuzhou City (CN); XCMG American Research Corporation, Naperville, IL (US)

(72) Inventors: Zhike Song, Xuzhou City (CN); Jiawen Geng, Xuzhou City (CN); Yuzhong Dong, Xuzhou City (CN); Dongyang Du, Xuzhou City (CN)

(21) Appl. No.: 17/966,177

(22) Filed: Oct. 14, 2022

(30) Foreign Application Priority Data
Oct. 19, 2021 (CN) 202111206961.4

(51) Int. Cl. B60N 2/52; B60N 2/50

(52) U.S. Cl. CPC B60N 2/522; B60N 2/501; B60N 2/525

(57) ABSTRACT

A seat adjusting structure includes a seat body. A damping force unit is installed at an upper end of the seat body, and a cab connecting plate is installed at a lower end of the seat body. An electronic controller and a seat weight sensor are installed between the damping force unit and the cab connecting plate. A rigidity unit and an operator presence indicator are installed at a lower part of the damping force unit, and a seat damper is installed above the cab connecting plate. The operator presence indicator detects whether an operator exists, while the seat weight sensor detects whether the weight of the operator is within a set range. The electronic controller receives detection signals from the operator presence indicator and the seat weight sensor and controls the damping force unit and the rigidity unit to adjust the rigidity and damping force of the seat damper.

### TECHNICAL FIELD

The invention relates to a seat adjusting structure, an adjusting method thereof and an engineering machinery seat, belonging to the field of engineering machinery.

### BACKGROUND

Comfortable seats help drivers relieve driving fatigue and improve driving comfort and safety. A seat damper provides rigidity and damping force. The adjustment of the rigidity and damping force of the seat damper is to meet the driving needs of drivers with different weights. The seat damper is a main functional component for seat comfort adjustment.

According to an existing device for adjusting damping force of a seat damper (CN201320646645.3), an adjustable damping cylinder is hinged between inner and outer connecting rods of the seat damper, an inner rod is sleeved with a piston rod of the adjustable damping cylinder, the inner rod is provided with a valve block for adjusting the size of a damping hole in the damping cylinder which runs through upper and lower cavities of a piston, and an end of the piston rod is provided with an inner rod rotating device which is connected to a damping adjusting handle through a stay wire, and by rotating the damping adjusting handle, the opening degree of the damping hole by the valve block is controlled through the stay wire, so as to realize the adjustment of the damping force of the damper.

According to the above scheme, the opening degree of the damping hole of the damper is adjusted by the damping adjusting handle, the stay wire, a rocker arm and the inner rod in turn, so that the damping force is controlled, and the structure is simple. However, this scheme has the following disadvantages:

(1) Only the damping force can be manually adjusted, and since the damping performance of a seat is determined by both rigidity and damping force, the effect is limited; and

(2) Seats with fixed rigidity and damping force provide different levels of damping comfort for drivers with different weights, drivers within a certain weight range might feel uncomfortable, and drivers or operators generally do not know how much damping force is appropriate or the best range of damping force, so adjustment is blind.

### SUMMARY OF THE DISCLOSURE

In view of the problems existing in the prior art, the invention provides a seat adjusting structure, an adjusting method thereof and an engineering machinery seat. The seat can be automatically adjusted by detecting whether an operator exists and the weight of the operator, and the rigidity and damping force of the seat can be automatically adjusted to preset optimal values.

In order to achieve the above object, the seat adjusting structure provided by the invention comprises a seat body, wherein a damping force unit is installed at an upper end of the seat body, a cab connecting plate is installed at a lower end of the seat body, an electronic controller and a seat weight sensor are installed between the damping force unit and the cab connecting plate, a rigidity unit and an operator presence indicator are installed at a lower part of the damping force unit, and a seat damper is installed above the cab connecting plate; and

the operator presence indicator is used to detect whether an operator exists, the seat weight sensor is used to detect whether the weight of the operator is within a set range, and the electronic controller is used to receive detection signals from the operator presence indicator and the seat weight sensor and control the damping force unit and the rigidity unit to adjust the rigidity and damping force of the seat damper.

As an improvement, the rigidity unit is an air spring with an electric inflation and deflation pump, and after receiving a signal from the electronic controller, the rigidity unit automatically starts the electric inflation and deflation pump to adjust a rigidity value of a seat.

As an improvement, the damping force unit is an adjustable damping rod and/or damping device.

As an improvement, the damping force unit is an electromagnetic damping rod or a wire pulling type damping rod, and after receiving a signal from the electronic controller, the damping force unit controls a current or a length of a wire to adjust the damping force.

As an improvement, the seat weight sensor comprises a gearbox speed sensor, a gear sensor and a hydraulic main pump rotation speed sensor.

The invention further provides an adjusting method of the seat adjusting structure, comprising:

when at least one sensor in the operator presence indicator indicates the presence of an operator and that the weight of the operator detected by the seat weight sensor is within the set range, automatically adjusting, by the electronic controller, the seat damper to a preset rigidity and damping force according to the weight of the operator; and

when at least one sensor in the operator presence indicator indicates that no operator exists and the weight of the operator detected by the seat weight sensor is beyond the reasonable set range, restoring, the electronic controller, the rigidity and damping force of the seat damper to initial set values.

As an improvement, automatically adjusting the seat damper to a preset rigidity and damping force according to the weight of the operator specifically comprises:

obtaining several interpolation values within the adjustment range of the rigidity and damping force of the seat, and arranging and combining the interpolation values;

designing a DOE test, adjusting the rigidity and damping force of different arrangements and combinations in sequence, and conducting a cab vibration comfort test;

setting a reasonable range for the weight of the operator and conducting interpolation within the range;

for a certain weight level, testing a selected standard for judging vibration comfort, and arranging acceleration sensors on a seat back, a cushion and a floor of a cab which respond to a square root value of comprehensive weighted acceleration of the cab; and

after testing, taking corresponding rigidity and damping values of the seat damper among optimal values in test results and predetermined critical ranges thereof as preset values;

the predetermined critical range being a rigidity and damping force range corresponding to 90% of the optimal values.

As an improvement, the operator presence indicator comprises a gearbox speed sensor, a gear sensor and a hydraulic main pump rotation speed sensor;

when a gearbox output speed detected by the gearbox speed sensor is non-zero, it indicates that an operator exists; when a gear detected by the gear sensor is not in neutral, it indicates that an operator exists; when a hydraulic main pump rotation speed detected by the hydraulic main pump rotation speed sensor is non-zero, it indicates that an operator exists;

when any one of the sensors indicates the presence of an operator and when the seat weight sensor detects that the weight of the operator is within the set range, the electronic controller controls the damping force unit and rigidity unit of the seat damper to automatically adjust the damping force and rigidity to the preset values; and

when any one of the sensors indicates that no operator exists and the weight of the operator detected by the seat weight sensor is beyond the reasonable set range, the electronic controller restores the rigidity and damping force of the seat damper to the initial set values.

The invention further provides an engineering machinery seat, comprising a seat body, wherein a seat back and a cushion are installed on the seat body, and the seat adjusting structure is installed at a lower part of the seat body.

The invention further provides an engineering machine, comprising an engineering machine body, wherein a cab is installed on the engineering machine body, and the engineering machine seat is installed in the cab.

Compared with the related art, the invention has the following beneficial effects.

(1) The invention helps drives relieve driving fatigue, reduce physical harm caused by vibration, and improve driving comfort and safety; when drivers with different weights have different requirements for the damping comfort of the seat, the requirements of the drivers can be met by adjusting the rigidity and damping force, or when road conditions change during driving, the seat can keep the best damping performance by adjusting the rigidity and damping force; and

(2) The weight of an operator and whether an operator exists can be detected, and the inflation rate and/or damping force of an air spring of the seat can be automatically adjusted, so that drivers with different weights can feel comfortable.

### BRIEF DESCRIPTION OF THE FIGURES

FIG. 1 is a first diagram of a seat adjusting structure of the invention;

FIG. 2 is a second diagram of a seat adjusting structure of the invention;

FIG. 3 is a flowchart of an adjusting method of the invention;

FIG. 4 is a method for determining preset values of rigidity and damping force of a seat damper according to the invention;

FIG. 5 is a structural diagram of an engineering machinery seat of the invention; and

FIG. 6 is a structural diagram of an engineering machine of the invention.

In the drawings: 1. damping force unit, 2. electronic controller, 3. first seat damper, 4. seat body, 5. second seat damper, 6. seat weight sensor, 7. cab connecting plate, 8. rigidity unit, 9. operator presence indicator, 10. seat back, 11. cushion, 12. cab, 13. engineering machine body.

### DETAILED DESCRIPTION

In order to make the object, technical scheme and advantages of the invention clearer, the invention will be further explained in detail. It should be understood that the specific embodiments described here are only for explaining the invention, and do not limit the scope of the invention.

Unless otherwise defined, all technical terms and scientific terms used herein have the same meanings as commonly understood by those skilled in the technical field of the invention. The terms used in the specification of the invention are only for the purpose of describing specific embodiments, and are not intended to limit the invention.

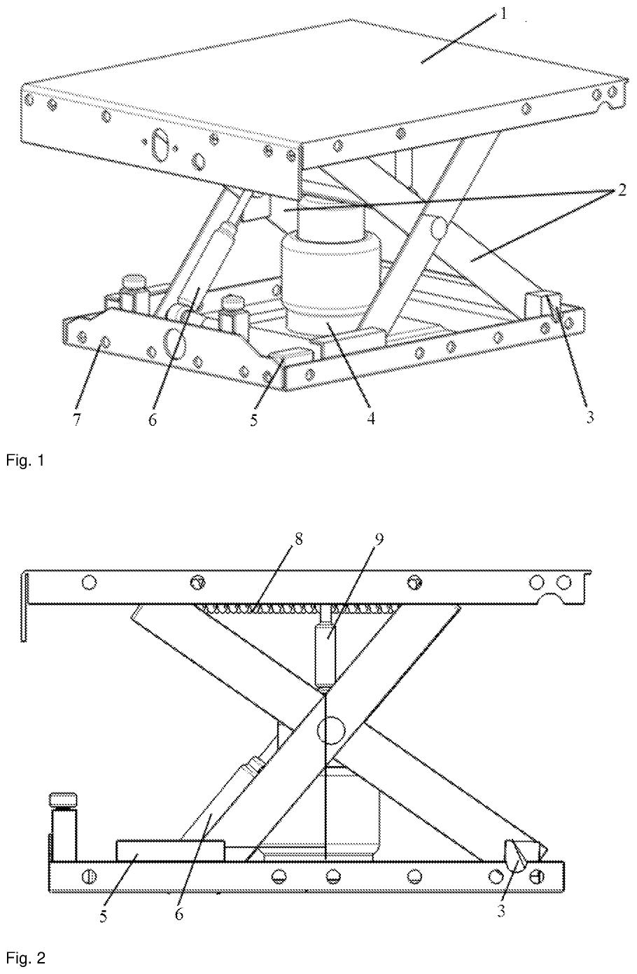

As shown in FIGS. 1 and 2, a seat adjusting structure comprises a seat body 4, wherein a damping force unit 1 is installed at an upper end of the seat body 4, a cab connecting plate 7 is installed at a lower end of the seat body, the cab connecting plate 7 is used for connection with a cab, an electronic controller 2 and a seat weight sensor 6 are installed between the damping force unit 1 and the cab connecting plate 7, a rigidity unit 8 and an operator presence indicator 9 are installed at a lower part of the damping force unit 1, and a first seat damper 3 and a second seat damper 5 are installed above the cab connecting plate 7; and

the operator presence indicator 9 is used to detect whether an operator exists, the seat weight sensor 6 is used to detect whether the weight of the operator is within a set range, and the electronic controller 2 is used to receive detection signals from the operator presence indicator 9 and the seat weight sensor 6 and control the damping force unit 1 and the rigidity unit 8 to adjust the rigidity and damping force of the seat damper.

As an improvement of the embodiment, the rigidity unit 8 is an air spring with an electric inflation and deflation pump, and after receiving a signal from the electronic controller 2, the rigidity unit 8 automatically starts the electric inflation and deflation pump to adjust a rigidity value of a seat.

As an improvement of the embodiment, the damping force unit 1 is an adjustable damping rod and/or damping device, the damping force unit 1 is an electromagnetic damping rod or a wire pulling type damping rod, and after receiving a signal from the electronic controller 2, the damping force unit 1 controls a current or a length of a wire to adjust the damping force.

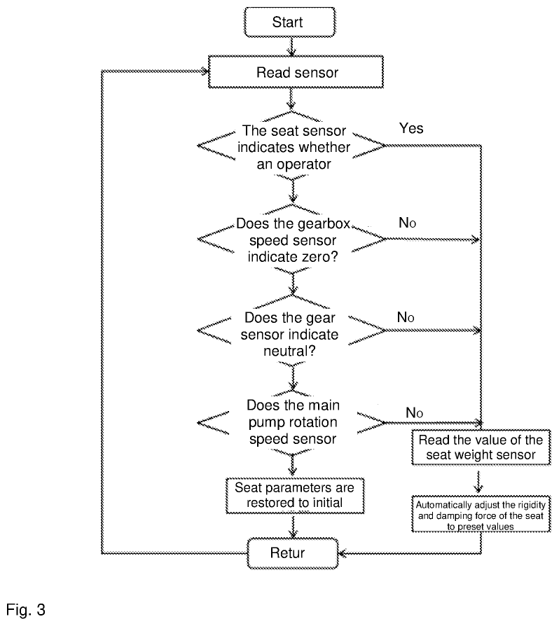

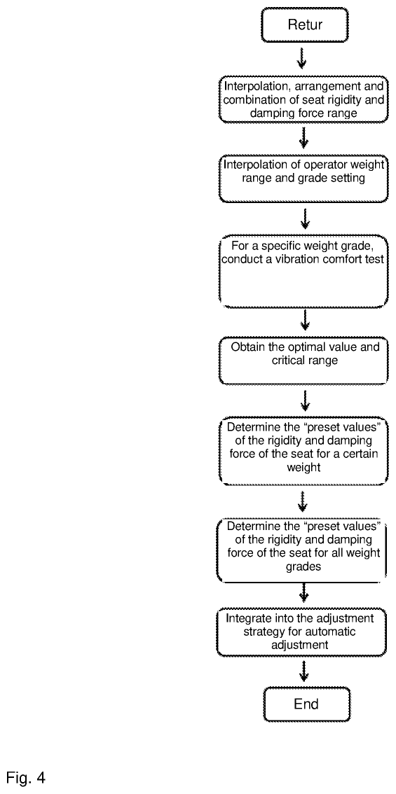

Further, as shown in FIGS. 3 and 4, the invention provides an adjusting method of the seat adjusting structure, comprising:

when at least one sensor in the operator presence indicator 9 indicates the presence of an operator and that the weight of the operator detected by the seat weight sensor 6 is within the set range, automatically adjusting, the electronic controller 2, the seat damper to a preset rigidity and damping force according to the weight of the operator; and

when at least one sensor in the operator presence indicator 9 indicates that no operator exists and the weight of the operator detected by the seat weight sensor 6 is beyond the reasonable set range, restoring, the electronic controller 2, the rigidity and damping force of the seat damper to initial set values.

As an improvement of the embodiment, automatically adjusting the seat damper to a preset rigidity and damping force according to the weight of the operator specifically comprises:

obtaining several interpolation values within the adjustment range of the rigidity and damping force of the seat, and arranging and combining the interpolation values according to a certain method;

designing a DOE test, adjusting the rigidity and damping force of different arrangements and combinations in sequence, and conducting a cab vibration comfort test;

setting a reasonable range for the weight of the operator and conducting interpolation within the range according to certain rules, for example, setting the weight range of adult operators as 40-150 kg, with every 10 kg as a grade;

for a certain weight level, testing a selected standard for judging vibration comfort, such as ISO 2631, and arranging acceleration sensors on a seat back, a cushion and a floor of a cab which respond to a square root value of comprehensive weighted acceleration of the cab; and

after testing, taking corresponding rigidity and damping values of the seat damper among optimal values in test results and predetermined critical ranges thereof as preset values;

the predetermined critical range being a rigidity and damping force range corresponding to 90% of the optimal values.

For each weight grade of operators, there is a corresponding preset value, which is integrated into the electronic controller 2 of the seat to ensure the best damping effect when the seat is automatically adjusted. The preset values of the rigidity and damping force of the seat are determined according to the selected standard for judging vibration comfort and the method of the invention, which are universal. The preset values obtained by the method are integrated into a control program to realize intelligent control and avoid blind adjustment.

As an improvement of the embodiment, as shown in FIG. 4, the operator presence indicator 9 comprises a gearbox speed sensor, a gear sensor and a hydraulic main pump rotation speed sensor;

when a gearbox output speed detected by the gearbox speed sensor is non-zero, it indicates that an operator exists; when a gear detected by the gear sensor is not in neutral, it indicates that an operator exists; when a hydraulic main pump rotation speed detected by the hydraulic main pump rotation speed sensor is non-zero, it indicates that an operator exists;

when any one of the sensors indicates the presence of an operator and when the seat weight sensor 6 detects that the weight of the operator is within the set range, the electronic controller 12 controls the damping force unit 1 and rigidity unit 8 to automatically adjust the damping force and rigidity to the preset values; and

when any one of the sensors indicates that no operator exists and the weight of the operator detected by the seat weight sensor 6 is beyond the reasonable set range, the electronic controller 2 controls the damping force unit 1 and rigidity unit 8 to restore the rigidity and damping force of the seat damper to the initial set values.

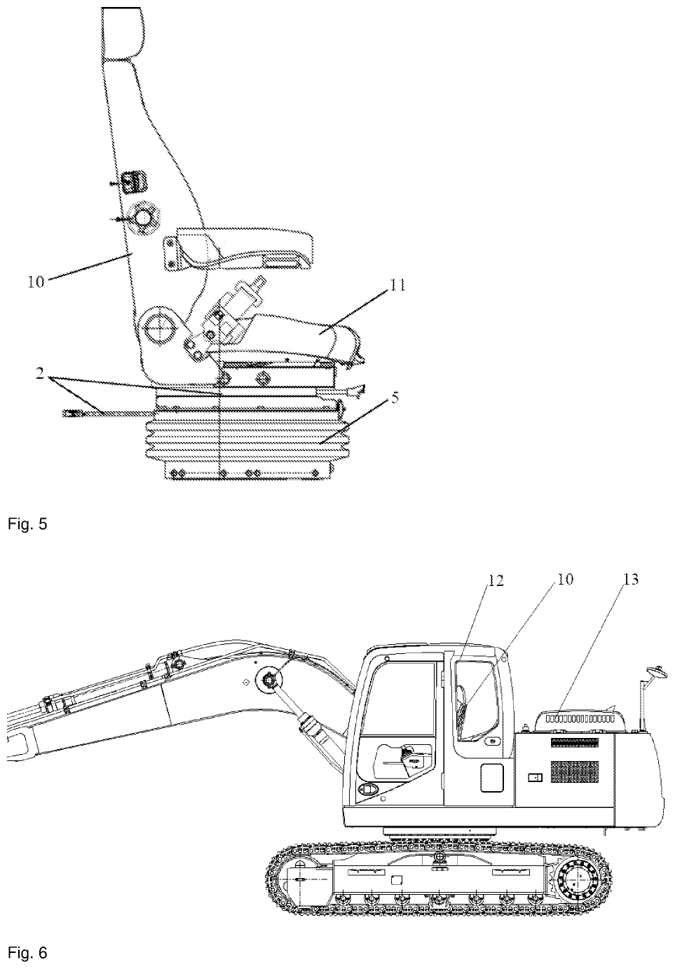

Further, as shown in FIG. 5, the invention provides an engineering machinery seat, comprising a seat body, wherein a seat back 10 and a cushion 11 are installed on the seat body, and the seat adjusting structure is installed at a lower part of the seat body.

Finally, as shown in FIG. 6, the invention provides an engineering machine, comprising an engineering machine body 13, wherein the engineering machine body 13 is provided with a cab 12,

an electronic controller 2 connected to the engineering machine body 13,

a seat weight sensor communicated with the electronic controller 2,

a gearbox speed sensor communicated with the electronic controller 2,

a gear sensor communicated with the electronic controller 2, and

a hydraulic main pump rotation speed sensor communicated with the electronic controller 2.

The electronic controller 2 has a seat adjustment function, that is, to automatically adjust the rigidity and/or damping force of the seat by detecting the weight of an operator. Here, the model of the electronic controller 2 may be IMCT365.

The invention helps drives relieve driving fatigue, reduce physical harm caused by vibration, and improve driving comfort and safety. When drivers with different weights have different requirements for the damping comfort of the seat, the requirements of the drivers can be met by adjusting the rigidity and damping force, or when road conditions change during driving, the seat can keep the best damping performance by adjusting the rigidity and damping force.

The weight of an operator and whether an operator exists can be detected, and the inflation rate and/or damping force of an air spring of the seat can be automatically adjusted, so that drivers with different weights can feel comfortable.

The foregoing are only preferred embodiments of the invention, and are not intended to limit the invention. Any modifications, equivalent substitutions, improvements, etc. made within the spirit and principle of the invention shall be included in the scope of protection of the invention.

What is claimed is:

1. A seat adjusting structure, comprising a seat body, wherein a damping force unit is installed at an upper end of the seat body, a cab connecting plate is installed at a lower end of the seat body, an electronic controller and a seat weight sensor are installed between the damping force unit and the cab connecting plate, a rigidity unit and an operator presence indicator are installed at a lower part of the damping force unit, and a seat damper is installed above the cab connecting plate;
the operator presence indicator is used to detect whether an operator exists, the seat weight sensor is used to detect whether a weight of the operator is within a set range, and the electronic controller is used to receive detection signals from the operator presence indicator and the seat weight sensor and control the damping force unit and the rigidity unit to adjust a rigidity and damping force of the seat damper.

2. The seat adjusting structure according to claim 1, wherein the rigidity unit is an air spring with an electric inflation and deflation pump, and after receiving a signal from the electronic controller, the rigidity unit automatically starts the electric inflation and deflation pump to adjust a rigidity value of a seat.

3. The seat adjusting structure according to claim 1, wherein the damping force unit is an adjustable damping rod and/or damping device.

4. The seat adjusting structure according to claim 3, wherein the damping force unit is an electromagnetic damping rod or a wire pulling type damping rod, and after receiving a signal from the electronic controller, the damping force unit controls a current or a length of a wire to adjust the damping force.

5. The seat adjusting structure according to claim 1, wherein the seat weight sensor comprises a gearbox speed sensor, a gear sensor and a hydraulic main pump rotation speed sensor.

6. An adjusting method of the seat adjusting structure according to claim 1, comprising:
when at least one sensor in the operator presence indicator indicates the presence of an operator and that the weight of the operator detected by the seat weight sensor is within the set range, automatically adjusting, by the electronic controller, the seat damper to a preset rigidity and damping force according to the weight of the operator; and
when at least one sensor in the operator presence indicator indicates that no operator exists and the weight of the operator detected by the seat weight sensor is beyond the reasonable set range, restoring, by the electronic controller, the rigidity and damping force of the seat damper to initial set values.

7. The adjusting method of the seat adjusting structure according to claim 6, wherein automatically adjusting the seat damper to a preset rigidity and damping force according to the weight of the operator specifically comprises:
obtaining several interpolation values within an adjustment range of the rigidity and damping force of the seat, and arranging and combining the interpolation values;
designing a DOE test, adjusting the rigidity and damping force of different arrangements and combinations in sequence, and conducting a cab vibration comfort test;
setting a reasonable range for the weight of the operator and conducting interpolation within the range;
for a certain weight level, testing a selected standard for judging vibration comfort, and arranging acceleration sensors on a seat back, a cushion and a floor of a cab which respond to a square root value of comprehensive weighted acceleration of the cab; and
after testing, taking corresponding rigidity and damping values of the seat damper among optimal values in test results and predetermined critical ranges thereof as preset values;
the predetermined critical range being a rigidity and damping force range corresponding to 90% of the optimal values.

8. The adjusting method of the seat adjusting structure according to claim 6, wherein the operator presence indicator comprises a gearbox speed sensor, a gear sensor and a hydraulic main pump rotation speed sensor;
when a gearbox output speed detected by the gearbox speed sensor is non-zero, it indicates that an operator exists; when a gear detected by the gear sensor is not in neutral, it indicates that an operator exists; when a hydraulic main pump rotation speed detected by the hydraulic main pump rotation speed sensor is non-zero, it indicates that an operator exists;
when any one of the sensors indicates the presence of an operator and when the seat weight sensor detects that the weight of the operator is within the set range, the electronic controller controls the damping force unit and rigidity unit of the seat damper to automatically adjust the damping force and rigidity to the preset values; and
when any one of the sensors indicates that no operator exists and the weight of the operator detected by the seat weight sensor is beyond the reasonable set range, the electronic controller restores the rigidity and damping force of the seat damper to the initial set values.

9. An engineering machinery seat, comprising a seat body, wherein a seat back and a cushion are installed on the seat body, and the seat adjusting structure according to claim 1 is installed at a lower part of the seat body.

10. An engineering machine, comprising an engineering machine body, wherein a cab is installed on the engineering machine body, and the engineering machine seat according to claim 9 is installed in the cab.
